(19) United States
(12) Patent Application Publication
(10) Pub. No.: US 2014/0298242 A1
(43) Pub. Date: Oct. 2, 2014

(54) Method for controlling microblog display, microblog client and computer storage medium

(71) Applicant: TENCENT TECHNOLOGY (SHENZHEN) COMPANY LIMITED, Shenzhen, Guangdong (CN)

(72) Inventors: Jing Zhang, Shenzhen (CN); Meina Li, Shenzhen (CN); Yang Li, Shenzhen (CN); Danzhi Chen, Shenzhen (CN); Nian Liu, Shenzhen (CN); Qunli Ma, Shenzhen (CN); Chen Zhang, Shenzhen (CN); Yufei Liu, Shenzhen (CN); Jun Ye, Shenzhen (CN); Jie Hou, Shenzhen (CN)

(21) Appl. No.: 14/355,991

(22) PCT Filed: Apr. 28, 2013
(86) PCT No.: PCT/CN2013/075007

§ 371 Date: May 2, 2014

(30) Foreign Application Priority Data
May 23, 2012 (CN) 201210161422.8

(51) Int. Cl. G06F 3/0481; G06F 3/0484

(52) U.S. Cl. CPC G06F 3/04812; G06F 3/04842
USPC 715/779

(57) ABSTRACT

A method for controlling microblog display, a microblog client and a computer storage medium are described, which pertain to microblog technology. A display interface of microblog consists of a main display area for displaying microblog messages and a promotion display area for displaying recommended messages. The method includes that: a micro-blog message is acquired and displayed in the main display area; recommended messages are pulled from a microblog server at a preset frequency, or/and recommended messages pushed by the microblog server at a preset frequency are received; the recommended messages are displayed in the promotion display area. By displaying the microblog messages in the main display area and displaying the recommended messages in the promotion display area, the recommended messages are pushed actively to users such that the users may acquire the recommended messages without refreshing the microblog and switching the display interface back and forth, visual experience of users is therefore guaranteed.

The present patent application claims priority to Chinese Patent Application No.: 201210161422.8, filed on May 23, 2012 by TENCENT Technology (Shenzhen) Company Limited, titled “Method for controlling microblog display and microblog client”, the disclosure of which is incorporated by reference herein in its entirety.

### TECHNICAL FIELD

The disclosure relates to microblog technology, and in particular to a method for controlling microblog display, microblog client and computer storage medium.

### BACKGROUND

Microblog is a platform for sharing, spreading and acquiring information based on a user relationship. A user may build a personal microblog platform through WEB, Wireless Application Protocol (WAP) and various clients for information sharing timely.

In the prior art, the microblog provides a square hall that provides entrance navigation of all kinds of microblog messages. The user may acquire corresponding microblog messages via the entrance navigation of all kinds of microblog messages displayed in the square hall. For example, the square hall provides entrance navigations of a popular broadcast, of a popular topic or of microblog messages related to the user, when the user looks over the popular broadcast, the user may click a popular broadcast entrance in the square hall to acquire and display the popular broadcast. At this moment, if the user wants to look over the popular topic, the user needs to quit the current displayed popular broadcast and return to the square hall, and then clicks a popular topic entrance in the square hall to acquire and display the popular topic.

It can be seen from the above that, in the prior art, the user has to return to the square hall repeatedly, and acquires corresponding microblog messages via the entrance navigation of all kinds of microblog message provided by the square hall. Such an operation is too complex. Additionally, the whole display interface has to be switched repeatedly, which results in a relatively large user visual span and relatively poor user visual experience.

### SUMMARY

To solve the problems of the prior art, embodiments of the disclosure provide a method, a microblog client and a computer storage medium for controlling microblog display.

An embodiment of the disclosure provides a method for controlling microblog display. A display interface of the microblog consists of a main display area for displaying microblog messages and a promotion display area for displaying recommended messages, the method includes the following steps:
a microblog message is acquired, and the microblog message is displayed in the main display area;
recommended messages are pulled from a microblog server at a preset frequency, or/and recommended messages pushed by the microblog server at a preset frequency are received; and the recommended messages are displayed in the promotion display area, the recommended message includes at least one of the followings: a popular broadcast, a popular topic, recommended friends to be concerned, a recommended application, and updated messages of concerned friends.

An embodiment of the disclosure provides a microblog client, a display interface of which consists of a main display area for displaying microblog messages and a promotion display area for displaying recommended messages. The microblog client includes a first controlling display module and a second controlling display module;
the first controlling display module is configured to acquire a microblog message and display the microblog message in the main display area; and
the second controlling display module is configured to: pull recommended messages from a microblog server at a preset frequency, or/and receive recommended messages pushed at a preset frequency by the microblog server; and display the recommended messages in the promotion display area, the recommended messages includes at least one of the followings: a popular broadcast, a popular topic, recommended friends to be concerned, a recommended application and updated messages of concerned friends.

The disclosure provides a computer storage medium storing a computer program that, when executed, causes the above method for controlling microblog display to be performed.

The advantages of the technical solutions provided by the embodiments of the disclosure are as follows: by displaying the acquired microblog message in the main display area and displaying the acquired recommended messages in the promotion display area, the recommended messages are pushed to users actively such that the users can acquire the recommended messages without refreshing the microblog, and the display interface is not switched back and forth, visual experience of users is therefore guaranteed.

### BRIEF DESCRIPTION OF THE DRAWINGS

In order to illustrate the technical solutions in the embodiments of the disclosure more clearly, drawings referred to in the embodiments of the disclosure are briefly described below. It should be understood that the drawings described below are only some embodiments of the disclosure, and other drawings can be acquired by those skilled in the art according to these drawings without exercising inventive skill.

FIG. 1 illustrates a flow chart of method for controlling microblog display according to embodiment 1 of the disclosure;

FIG. 2 illustrates a flow chart of method for controlling microblog display according to embodiment 2 of the disclosure;

FIG. 3 illustrates an example diagram of message display according to the embodiment 2 of the disclosure;

FIG. 4 illustrates an example diagram of process of hiding recommended message displayed in a promotion display area provided by the embodiment 2 of the disclosure;

FIG. 5 illustrates an example diagram of process of refreshing the display of recommended message hided within the promotion display area provided by the embodiment 2 of the disclosure;

FIG. 6 illustrates an example diagram of process of displaying a navigation toolbar in the promotion display area provided by the embodiment 2 of the disclosure;

FIG. 7 illustrates an example diagram of process of hiding the navigation toolbar displayed in the promotion display area provided by the embodiment 2 of the disclosure;

FIG. 8 illustrates an example diagram of process of recommended message scroll display in the promotion display area provided by the embodiment 2 of the disclosure;

FIG. 9 illustrates a schematic structure of a first microblog client provided by an embodiment 3 of the disclosure;

FIG. 10 illustrates a schematic structure of a second microblog client provided by the embodiment 3 of the disclosure;

FIG. 11 illustrates a schematic structure of a third microblog client provided by the embodiment 3 of the disclosure; and

FIG. 12 illustrates a schematic structure of a fourth microblog client provided by the embodiment 3 of the disclosure;

### DETAILED DESCRIPTION

In order to make the purpose, the technical solutions and the advantages of the disclosure more clearly, embodiments of the disclosure are elaborated below in conjunction with the accompanying drawings.

### Embodiment 1

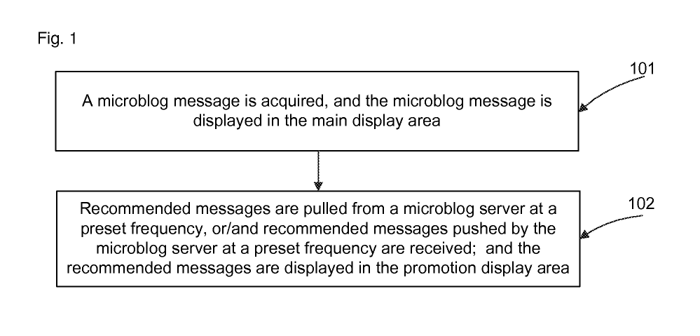

As shown in FIG. 1, a method for controlling microblog display is provided. A display interface of the microblog consists of a main display area for displaying microblog messages and a promotion display area for displaying recommended messages. The method includes the following steps:

At step 101, a microblog message is acquired, and the microblog message is displayed in the main display area;

At step 102, recommended messages are pulled from a microblog server at a preset frequency, or/and recommended messages pushed by the microblog server at a preset frequency are received; and the recommended messages are displayed in the promotion display area. The recommended messages includes at least one of the followings: a popular broadcast, a popular topic, recommended friends to be concerned, a recommended application, and updated messages of concerned friends.

The advantages of the technical solutions provided by the embodiment are as follows: by displaying the acquired microblog message in the main display area and displaying the acquired recommended messages in the promotion display area, the recommended messages are pushed to users actively such that the users can acquire the recommended messages without refreshing the microblog, and the display interface is not switched back and forth, visual experience of users is therefore guaranteed.

### Embodiment 2

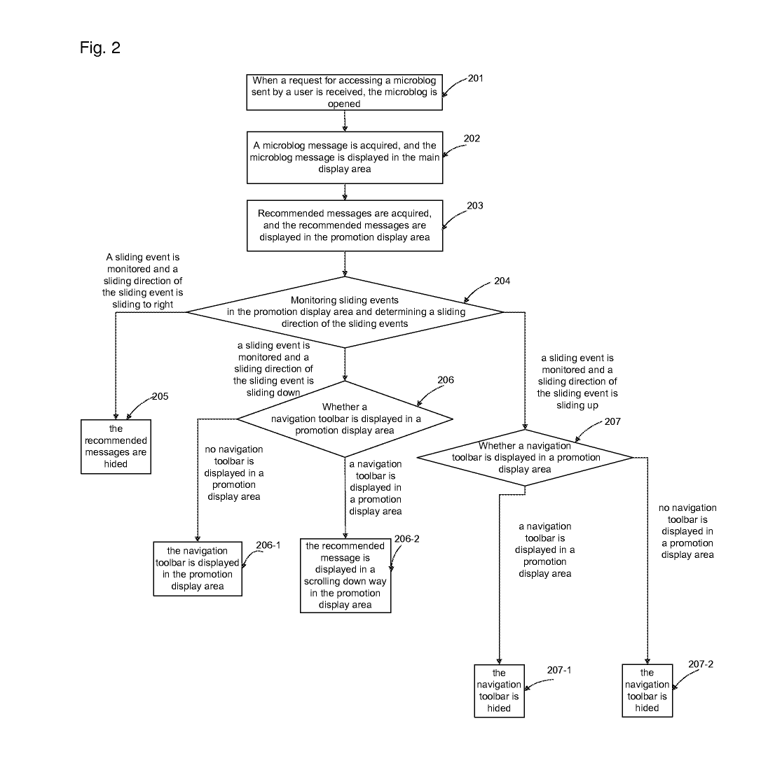

As shown in FIG. 2, a method for controlling microblog display is provided by an embodiment of the disclosure. A display interface of the microblog consists of a main display area for displaying microblog messages and a promotion display area for displaying recommended messages. The method may be performed by user equipment, such as a tablet computer. Furthermore, the method may be performed by a microblog client configured on the user equipment, which includes the following steps:

At step 201, when a request for accessing a microblog sent by a user is received, the microblog is opened, namely, a microblog client program is run.

At step 202, a microblog message is acquired, and the microblog message is displayed in the main display area. Specifically, a microblog message may be pulled from a microblog server. For example, microblog messages published by a concerned friend are pulled from the microblog server, and the pulled microblog messages are displayed in the main display area in the form of a list.

At step 203, recommended messages are acquired, and the recommended messages are displayed in the promotion display area. The recommended messages include at least one of the followings: a popular broadcast, a popular topic, recommended friends to be concerned, a recommended application and updated messages of concerned friends. For example, the acquired recommended messages may be popular topic or may include popular broadcast and popular topic.

In the embodiments of the disclosure, the popular broadcast refers to broadcast messages that are forwarded or commented on for the number of times greater than a predetermined value; the popular topic refers to topics that are commented on for the number of times greater than a predetermined value; the recommended friends to be concerned refer to recommended persons that are attractive or known to the users, such as schoolmates or colleagues; the recommended application refers to recommended applications that the users may be interested in, for example, some games; the updated messages of concerned friends include updated user information of the concerned friends (such as an avatar and signature) or updated microblog messages.

Preferably, the recommended messages are acquired by: pulling recommended messages from a microblog server at a preset frequency, or/and receiving recommended messages pushed at a preset frequency by the microblog server.

For example, the microblog server may push current popular topic and/or popular broadcast to the user equipment every one minute. In this way, the microblog may recommend timely current popular topic and/or popular broadcast to the users, that is, the users do not need to refresh the microblog on and on or switch to the square hall to acquire current popular topic and/or popular broadcast, visual experience of users is therefore guaranteed.

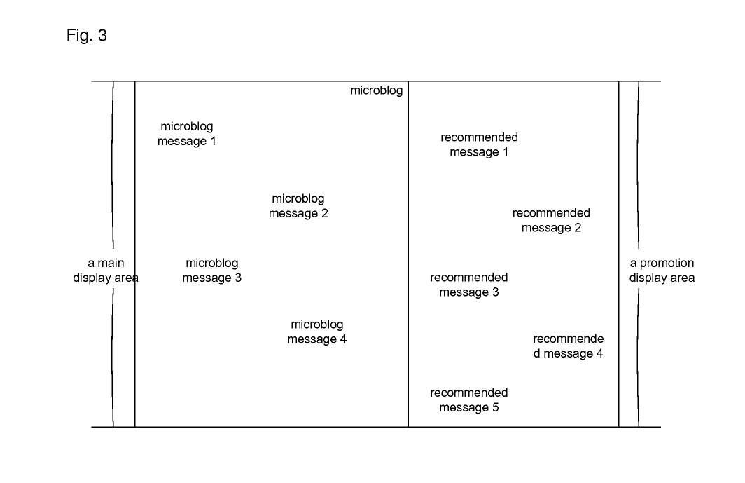

As shown in FIG. 3, an example diagram of message display provided by an embodiment of the disclosure. A display interface of a microblog consists of a main display area and a promotion display area. When a microblog message is acquired, the acquired microblog message is displayed in the main display area, such as microblog message 1 of a concerned friend named Xiaohong, microblog message 2 of a concerned friend named Xiaobai, microblog message 3 of a concerned friend named Niuer, and microblog message 4 of a concerned friend named Hanhan. When the recommended messages are acquired, the acquired recommended messages are displayed in the promotion display area, such as the recommended messages 1, 2, 3, 4 and 5, in which the recommended messages 1, 2 and 3 are popular topics while the recommended messages 4 and 5 are popular broadcasts.

It is should be noted that there is no limit on the execution sequence between step 202 and step 203.

Furthermore, the method according to the embodiment of the disclosure may further include step 204 of monitoring sliding events in the promotion display area and determining a sliding direction of the sliding events.

When a sliding event is monitored and the sliding event is a gesture operation of sliding to right, a step 205 is then performed;
when a sliding event is monitored and the sliding event is a gesture operation of sliding down, a step 206 is then performed; and
when a sliding event is monitored and the sliding event is a gesture operation of sliding up, a step 207 is then performed.

In the embodiment of the disclosure, when a user operates the promotion display area through a touchpad, sliding events will happen, which may be monitored by a preset hardware Application Programming Interface (API). After a sliding event is monitored, the sliding event may be processed by a sliding event processing function to determine the sliding direction of the sliding event.

At step 205, the recommended messages are hided. Specifically, the recommended messages are moved gradually to a boundary position of the promotion display area, such as right side of the promotion display area, until the recommended messages disappear at the boundary of the promotion display area.

At step 206, it is determined that whether there is a navigation toolbar in the promotion display area. The navigation toolbar provides a entrance navigation of an application function, for example, the navigation toolbar provides the entrance navigation of an clear function for clearing the recommended messages displayed in the promotion display area.

If no navigation toolbar is displayed in the promotion display area, a step 206-1 is then performed;
if the navigation toolbar is displayed in the promotion display area, a step 206-2 is then performed.

At step 206-1, the navigation toolbar is displayed in the promotion display area. Generally, the navigation toolbar is displayed at the top position of the promotion display area.

At step 206-2, the recommended message is displayed in a scrolling down way in the promotion display area.

At step 207, it is determined that whether the navigation toolbar is displayed in the promotion display area;
if the navigation toolbar is displayed in the promotion display area, a step 207-1 is then performed;
if no navigation toolbar is displayed in the promotion display area, a step 207-2 is then performed.

At step 207-1, the navigation toolbar is hided. For example, the navigation toolbar displayed at the top position of the promotion display area is retracted from the top position, the step retracting the navigation toolbar from the top position may include: adjusting a transparency of the navigation toolbar displayed at the top position until the navigation toolbar displayed at the top position is hided, or moving gradually the navigation toolbar displayed at the top position out of the promotion display area from the top position.

At step 207-2, the recommended message is displayed in a scrolling up way in the promotion display area.

Furthermore, after the recommended messages displayed in the promotion display area are hided, the method further includes the following steps:
sliding events in the promotion display area are monitored;
when the sliding event is monitored, and the sliding event is a gesture operation of sliding to left, the hided recommended message is redisplayed in the promotion display area. Specifically, the recommended messages are gradually moved from the boundary position of the promotion display area to the promotion display area, and the recommended messages are displayed in the promotion display area.

Furthermore, for the recommended messages displayed in the promotion display area, the method further includes the following steps:
when an access request for an avatar tag within the recommended message is received, information of a user, who publishes the recommended messages, is displayed in a popping box way in the promotion display area; and
when an access request for the recommended messages is received, detailed content of the recommended messages is displayed in a popping box way in the promotion display area.

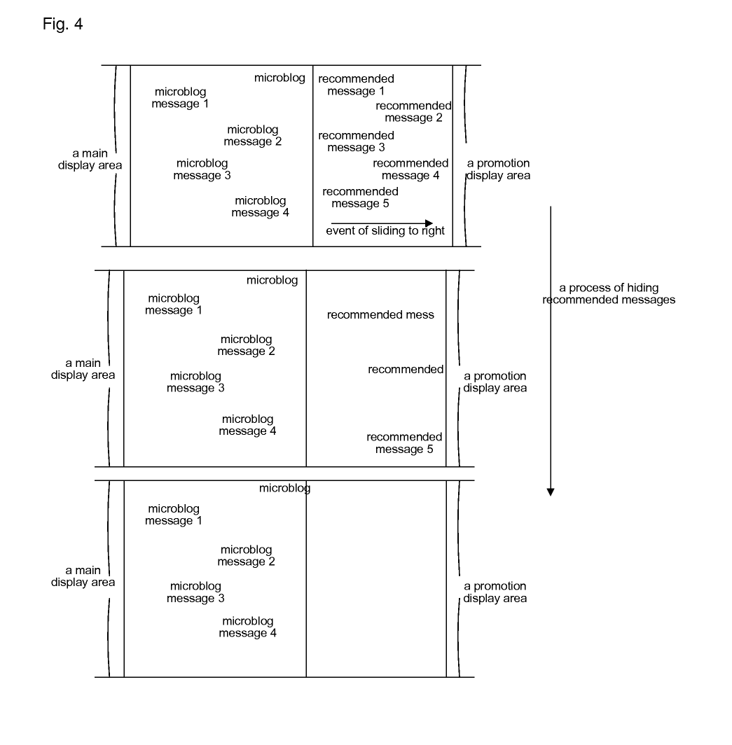

FIG. 4 illustrates an example diagram of process of hiding recommended message displayed in a promotion display area provided by an embodiment of the disclosure. When a sliding event is monitored in the promotion display area and the sliding event is sliding to right, the recommended messages displayed in the promotion display area are moved gradually to a boundary position on right side of the promotion display area, until the displayed recommended messages disappear at a boundary on the right side of the promotion display area.

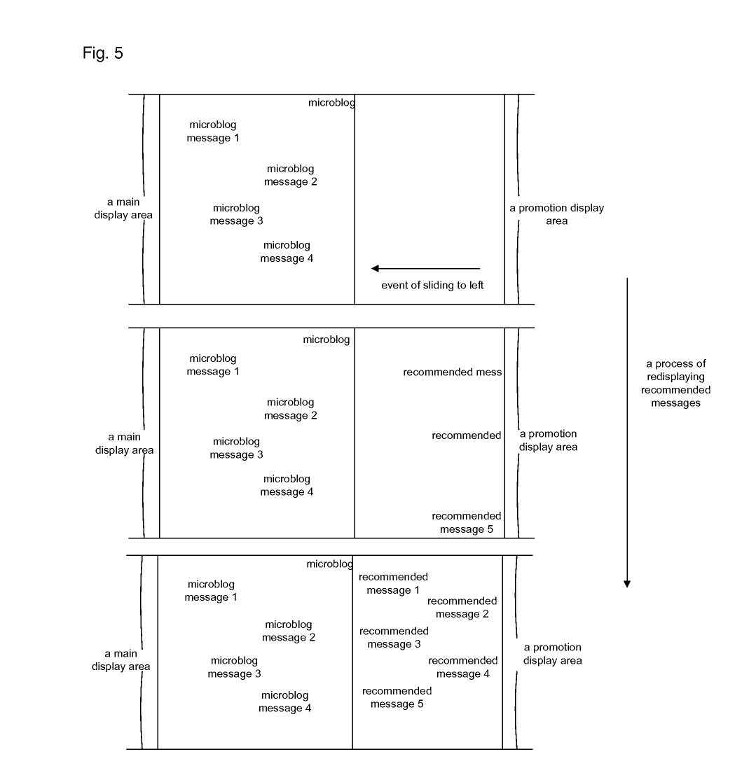

FIG. 5 illustrates an example diagram of process of redisplaying recommended message hided in a promotion display area provided by an embodiment of the disclosure. After the recommended messages displayed in the promotion display area are hided in a way shown in FIG. 4, when a sliding event is monitored in the promotion display area and the sliding event is sliding to left, the hided recommended message is moved out from a boundary position on right side of the promotion display area, until the hided recommended message can be displayed completely in the promotion display area.

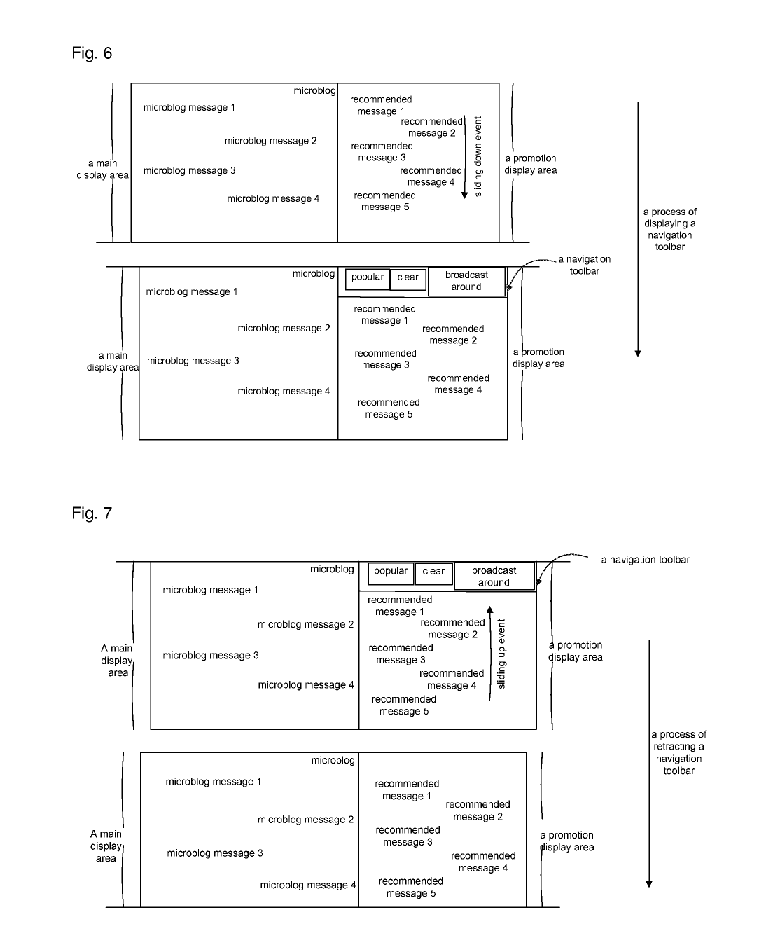

FIG. 6 illustrates an example diagram of process of displaying a navigation toolbar in a promotion display area provided by an embodiment of the disclosure. When a sliding event of sliding down is monitored in the promotion display area and recommended messages are displayed in the promotion display area, the navigation toolbar is displayed on the top position of the promotion display area. The navigation toolbar provides a entrance navigation of application function for users, so as to enable users to enter the corresponding application function according to application function entrances provided by the navigation toolbar to achieve the application function. As shown in FIG. 6, the application function may include “clear” function or function of “popular” information and function of acquiring “broadcast around”. In concrete applications, the navigation toolbar may certainly provide application functions that are not limited to the application functions shown in FIG. 6, and may be expanded according to this idea.

FIG. 7 illustrates an example diagram of process of hiding a navigation toolbar displayed in a promotion display area provided by an embodiment of the disclosure.

When a sliding event of sliding up is monitored in the promotion display area and recommended messages are displayed in the promotion display area, the navigation toolbar displayed on the top position of the promotion display area is retracted.

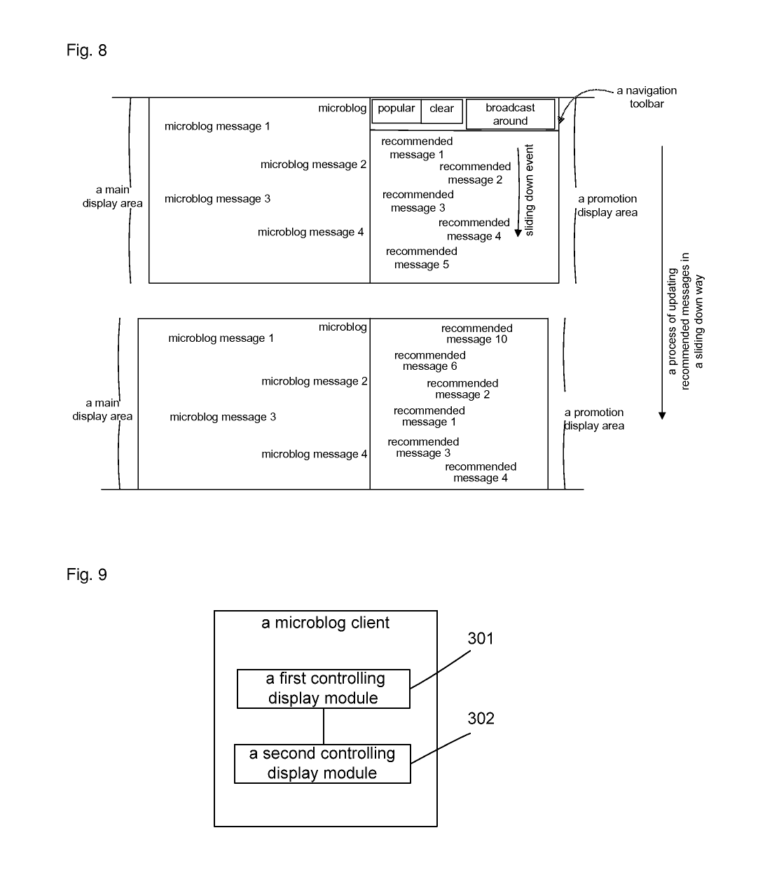

FIG. 8 illustrates an example diagram of process of displaying recommended messages in a scrolling way in a promotion display area provided by an embodiment of the disclosure. When a sliding event of sliding down is monitored in the promotion display area and a navigation toolbar is displayed on the top position of the promotion display area, the recommended message displayed in the promotion display area is scrolled down, so as to update recommended messages that are displayed.

The advantages of the technical solutions provided by embodiments of the disclosure are as follows: by displaying the acquired microblog message in the main display area and displaying the acquired recommended messages in the promotion display area, the recommended messages are pushed to users actively such that the users can acquire the recommended messages without refreshing the microblog, and the display interface is not switched back and forth, visual experience of users is therefore guaranteed.

### Embodiment 3

FIG. 9 illustrates a microblog client. A display interface of the microblog client consists of a main display area for displaying microblog messages and a promotion display area for displaying recommended messages. The microblog client includes a first controlling display module 301 and a second controlling display module 302.

The first controlling display module 301 is configured to acquire a microblog message, and to display the microblog message in the main display area; and
the second controlling display module 302 is configured to: pull recommended messages from a microblog server at a preset frequency, or/and receive recommended messages pushed at a preset frequency by the microblog server; and display the recommended messages in the promotion display area. The recommended message includes at least one of the followings: a popular broadcast, a popular topic, recommended friends to be concerned, a recommended application and updated messages of concerned friends.

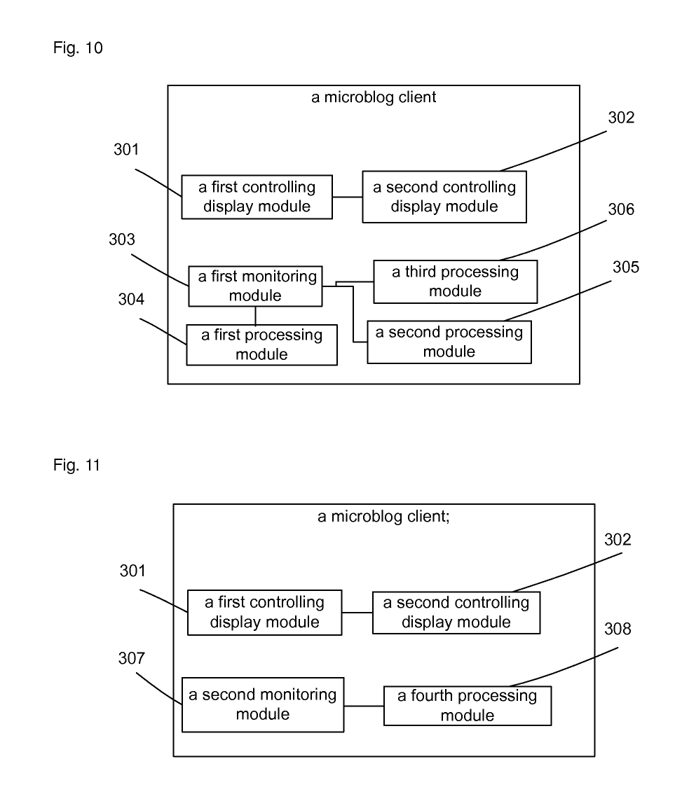

As shown in FIG. 10, a microblog client of the embodiment shown in FIG. 9 of the disclosure further includes a first monitoring module 303, a first processing module 304, a second processing module 305 and a third processing module 306.

The first monitoring module 303 is configured to monitor sliding events in the promotion display area after the recommended message is displayed in the promotion display area;
the first processing module 304 is configured to hide the recommended messages when a sliding event is monitored and the sliding event is a gesture operation of sliding to right;
the second processing module 305 is configured to: determine whether a navigation toolbar is displayed in the promotion display area, when a sliding event is monitored and the sliding event is a gesture operation of sliding down; display the navigation toolbar in the promotion display area if no navigation toolbar is displayed in the promotion display area; display the recommended messages in a scrolling down way in the promotion display area if the navigation toolbar is displayed in the promotion display area; and
the third processing module 306 is configured to: determine whether a navigation toolbar is displayed in the promotion display area, when a sliding event is monitored and the sliding event is a gesture operation of sliding up; hide the navigation toolbar if the navigation toolbar is displayed in the promotion display area; display the recommended messages in a scrolling up way in the promotion display area if no navigation toolbar is displayed in the promotion display area.

The first processing module 304 is configured to move gradually the recommended messages to a boundary position of the promotion display area, until the recommended messages disappear at the boundary of the promotion display area.

Preferably, as shown in FIG. 11, the microblog client of an embodiment shown in FIG. 9 of the disclosure further includes a second monitoring module 307 and a fourth processing module 308.

The second monitoring module 307 is configured to monitor sliding events in the promotion display area after the recommended message displayed in the promotion display area are hided; and
the fourth processing module 308 is configured to redisplay the hided recommended messages in the promotion display area when a sliding event is monitored and the sliding event is a gesture operation of sliding to left.

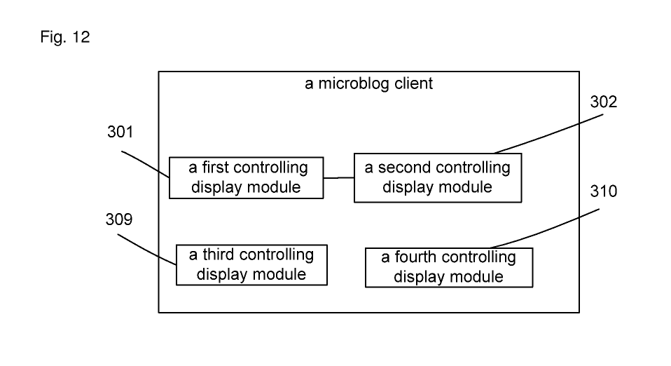

Preferably, as shown in FIG. 12, the microblog client of the embodiment shown in FIG. 9 of the disclosure further includes a third controlling display module 309 and a fourth controlling display module 310.

The third controlling display module 309 is configured to display information of a user, who publishes the recommended messages, in a popping box way in the promotion display area, when an access request for an avatar tag within the recommended message is received; and
the fourth controlling display module 310 is configured to display detailed content of the recommended messages in a popping box way in the promotion display area, when an access request for the recommended messages is received.

The advantages of the technical solutions provided by embodiments of the disclosure are as follows: by displaying the acquired microblog message in the main display area and displaying the acquired recommended messages in the promotion display area, the recommended messages are pushed to users actively such that the users can acquire the recommended messages without refreshing the microblog, and the display interface is not switched back and forth, visual experience of users is therefore guaranteed.

It should be noted that the microblog client provided by the above embodiments is only illustrated through a partition of the above-mentioned function modules when controlling the microblog display. In practical applications, the above functions can be completed by different functional modules as required, namely, the internal structure of the microblog client is partitioned into different functional modules to complete all or part of the functions described above. In addition, the microblog client provided by the embodiment of the disclosure and the method embodiments for controlling microblog display belong to the same concept, with the specific implementation process described in the method embodiments in detail, which is not reproduced here.

Numbering of the embodiments is merely for illustration and does not indicate the preference of one embodiment over another.

When being implemented in the form of a software functional module and sold or used as a separate product, the method for controlling microblog display according to the embodiments of the present disclosure may be stored in a computer-readable medium. Based on such understanding, the technical solutions of the embodiments of the present disclosure essentially, or the part contributing to the prior art, may be implemented in the form of a software product. The computer software product is stored in a storage medium, including several instructions for instructing a computer device (which may be a personal computer, a server, a network device or the like) to execute all or a part of the method described in each embodiment of the present disclosure. The storage medium may be various mediums that can store program codes, such as a U-disk, a removable hard disk, a Read-Only Memory (ROM), a Random Access Memory (RAM), a magnetic disk, an optical disk, and so on. Therefore, the embodiments of the present disclosure are not limited to any specific combination of hardware and software.

Accordingly, an embodiment of the disclosure further provides a computer storage medium storing a computer program that, when executed, causes the method for controlling microblog display according to the embodiments of the disclosure to be performed.

The above description only refers to the preferred embodiments of the disclosure, and is not intended to limit the scope of the disclosure.

1. (canceled)

2. A method for controlling microblog display, wherein a display interface of microblog consists of a main display area for displaying microblog messages and a promotion display area for displaying recommended messages, the method comprising:
acquiring a microblog message, and displaying the microblog message in the main display area;
pulling recommended messages from a microblog server at a preset frequency, or/and receiving recommended messages pushed at a preset frequency by the microblog server;
displaying the recommended messages in the promotion display area, wherein the recommended messages comprise at least one of the followings: a popular broadcast, a popular topic, recommended friends to be concerned, a recommended application and updated messages of concerned friends;
monitoring sliding events in the promotion display area;
hiding the recommended messages, when a sliding event is monitored and the sliding event is a gesture operation of sliding to right;
determining whether a navigation toolbar is displayed in the promotion display area, when a sliding event is monitored and the sliding event is a gesture operation of sliding down; displaying the navigation toolbar in the promotion display area if no navigation toolbar is displayed in the promotion display area; displaying the recommended messages in a scrolling down way in the promotion display area if the navigation toolbar is displayed in the promotion display area; and
determining whether a navigation toolbar is displayed in the promotion display area, when a sliding event is monitored and the sliding event is a gesture operation of sliding up; hiding the navigation toolbar if the navigation toolbar is displayed in the promotion display area; displaying the recommended messages in a scrolling up way in the promotion display area if no navigation toolbar is displayed in the promotion display area.

3. The method according to claim 2, wherein the step of hiding the recommended messages comprises:
moving gradually the recommended messages to a boundary position of the promotion display area until the recommended messages disappear at a boundary of the promotion display area.

4. The method according to claim 2, further comprising the steps, after the step of hiding the recommended messages displayed in the promotion display area, of:
monitoring sliding events in the promotion display area; and
redisplaying the hided recommended messages in the promotion display area, when a sliding event is monitored and the sliding event is a gesture operation of sliding to left.

5. The method according to claim 2, further comprising
displaying information of a user, who publishes the recommended messages, in a popping box way in the promotion display area, when an access request for an avatar tag within the recommended messages is received; and
displaying detailed content of the recommended messages in a popping box way in the promotion display area, when an access request for the recommended messages is received.

6. (canceled)

7. A microblog client, wherein a display interface of the microblog client consists of a main display area for displaying microblog messages and a promotion display area for displaying recommended messages, the microblog client comprising:
a first controlling display module configured to acquire a microblog message and display the microblog message in the main display area;
a second controlling display module configured to: pull recommended messages from a microblog server at a preset frequency, or/and receive recommended messages pushed at a preset frequency by the microblog server; and display the recommended messages in the promotion display area, wherein the recommended message comprises at least one of the followings: a popular broadcast, a popular topic, recommended friends to be concerned, a recommended application, updated messages of concerned friends;
a first monitoring module configured to monitor sliding events in the promotion display area after the recommended messages are displayed in the promotion display area;
a first processing module configured to hide the recommended messages when a sliding event is monitored and the sliding event is a gesture operation of sliding to right;
a second processing module configured to: determine whether a navigation toolbar is displayed in the promotion display area, when a sliding event is monitored and the sliding event is a gesture operation of sliding down; display the navigation toolbar in the promotion display area if no navigation toolbar is displayed in the promotion display area; display the recommended messages in a scrolling down way in the promotion display area if the navigation toolbar is displayed in the promotion display area; and
a third processing module configured to: determine whether a navigation toolbar is displayed in the promotion display area, when a sliding event is monitored and the sliding event is a gesture operation of sliding up; hide the navigation toolbar if the navigation toolbar is displayed in the promotion display area; display the recommended messages in a scrolling up way in the promotion display area if no navigation toolbar is displayed in the promotion display area.

8. The microblog client according to claim 7, wherein the first processing module is configured to move gradually the recommended messages to a boundary position of the promotion display area until the recommended messages disappear at a boundary of the promotion display area.

9. The microblog client according to claim 7, further comprising:
a second monitoring module configured to monitor sliding events in the promotion display area after the recommended messages displayed in the promotion display area are hided; and
a fourth processing module configured to redisplay the hided recommended messages in the promotion display area when a sliding event is monitored and the sliding event is a gesture operation of sliding to left.

10. The microblog client according to claim 7, further comprising:
a third controlling display module configured to display information of a user, who publishes the recommended messages, in a popping box way in the promotion display area, when an access request for an avatar tag within the recommended message is received; and
a fourth controlling display module configured to display detailed content of the recommended messages in a popping box way in the promotion display area, when an access request for the recommended messages is received.

11. (canceled)
